(19) United States
(12) Patent Application Publication
(10) Pub. No.: US 2011/0196689 A1
(43) Pub. Date: Aug. 11, 2011

(54) HANDHELD TERMINAL, METHOD OF DRESSING IT UP, AND METHOD OF DELIVERING DRESS-UP DATA

(76) Inventor: Takumi Otani, Tokyo (JP)

(21) Appl. No.: 12/671,525

(22) PCT Filed: Jul. 22, 2008
(86) PCT No.: PCT/JP2008/063131

§ 371 Date: Feb. 1, 2010

(30) Foreign Application Priority Data
Aug. 1, 2007 (JP) 2007-200273

(51) Int. Cl. G09G 5/00; G06F 3/041; G06Q 30/00

(52) U.S. Cl. 705/1.1; 345/173; 345/204

(57) ABSTRACT

A mobile terminal which can change a picture displayed on a casing comprises a curved transparent casing (201) formed of a transparent material, a display member which is pasted on a rear face of the transparent casing (201), which can change a picture and which can keep displaying without power after changing is performed, memory unit for storing information to be displayed on the display member, and control unit for reading out the information from the memory unit and for controlling a display of the display member. The control unit is connected to a communication network, acquires information to be displayed on the display member from an external device through the communication network, and displays the information on the display member.

### TECHNICAL FIELD

The present invention relates to a mobile terminal, a method of dressing up the same, and a data distribution method, and more particularly, a mobile terminal which can change a picture displayed on a casing, a method of dressing up the same, and a dress-up data distribution method.

### BACKGROUND ART

Recently, services of customizing a screen display (including a wall paper, a font, and a menu icon nowadays) on an LCD (liquid crystal display) for each user become active businesses, and such businesses are likely to expand. If an exterior appearance is changeable in addition to an LCD display by downloading contents, amusement for a user increases, and such a change becomes a new business for a company which provides the contents.

There is a mobile terminal as a related example which can wear a plastic dress-up panel that is detachably attachable to a casing. This provides a new amusement for a user.

Such a plastic dress-up panel has, however, some factors which interfere with a design like a step, a protrusion, and a screw for attaching the panel to the casing.

Moreover, it is not possible for the user to increase the kinds of dress-up unless a dress-up panel provider physically increases the kinds of dress-up plastic panel. In contrast, if the kinds of dress-up plastic panel are increased at the provider side, a wasted stock may be created, design costs become requisite every time such a wasted stock is created, so that this becomes an economic burden to the provider.

Furthermore, such a plastic dress-up panel does not match recent trends of thinning of mobile terminals, so that substitutive methods and proposals become requisite.

Thus, there is an example mobile terminal which can realize dress-up without changing a plastic panel, and FIG. 12 shows such an example. FIG. 12 is a cross-sectional view of a mobile terminal which is a related example. FIG. 12 shows a cross-section of a casing of a foldable mobile terminal at a display face side as an example.

With reference to this figure, a display-side casing of the related mobile terminal as an example comprises an LCD 100, a backlight 101, a transparent casing 102, an LCD flames 103, 104, a backlight 105, an LCD 106, a screen 107, and a casing 108.

The LCD 106 configures the display face, the backlight 105 is provided at the rear thereof, and the screen 107 is provided at the front thereof. The LCD 106 and the backlight 105 are supported by the LCD flame 104, and the screen 107 is supported by the casing 108.

Conversely, the LCD 100 displays a dress-up screen, the backlight 101 is provided at the rear thereof, and the transparent casing 102 is provided at the front thereof.

The LCD 100 and the backlight 101 are supported by the LCD flame 103, and the transparent casing 102 is supported by the casing 108.

As an example, the transparent casing 102 has a curved face, so that there is a space 109 between the LCD 100 and the transparent casing 102.

According to this mobile terminal, the LCD 100 is used as a dress-up screen, but LCDs have some problems and limitations even though a display updating speed is fast.

First, it is not possible to bend LCDs, so that there is no problem if the surface finishing of the mobile terminal is flat, but the surface of the casing is often curved because design is basically important to mobile terminals. Accordingly, a structure having an integral curved face is desirable as such a design.

However, as shown in FIG. 12, when the LCD 100 is used as a dress-up screen, it is difficult to employ a structure integral with a curved face. Moreover, the LCD 100 is viewed from the exterior through the transparent casing 102, the space 109 must be empty, so that there is a wasted space.

Second, LCDs require power for a display operation itself. Moreover, it requires illumination by backlights because the visibility is poor if LCDs simply display a screen.

Conversely, there is a mobile terminal which employs an electronic paper as a dress-up screen in order to overcome the foregoing problem (see patent literature 1).

Due to advancement of the technology, electronic paper enable not only a monochrome display as it is previously permitted but also a color display, and some advantages, such as thin, flexible, power requisition only when it is rewritten become realized. In particular, improvement of the degree of freedom for design by attaching an electronic paper in a bent condition (although it is difficult by LCD display which is a related technology) and unnecessity of power after rewriting become great advantages for mobile terminals like cellular phones which, require energy saving.

FIG. 13 is a cross-sectional view showing an example of an electronic paper. With reference to this figure, the example electronic paper has a transparent film 302, a cholesteric liquid crystal (blue) 303, a cholesteric liquid crystal (green) 304, a cholesteric liquid crystal (red) 305, and a light absorption layer 306, all stacked together, an electrode 307 is attached to the stacked body, and the side face thereof is sealed by an encapsulation agent 308.

Intensities of lights which reflect due to a setting controlled by a driver (not shown) relative to white incident lights 301 are adjusted by the three cholesteric liquid crystals (blue, green, and red) 303 to 305, and a color is expressed. Basically, light do not transmit the film of the light absorption layer 306, so that the space 109 in FIG. 12 can be used as a free space.

According to the mobile terminal of patent literature 1, as shown in FIG. 2 of this literature, an electronic paper (exterior display device) 106 is pasted on a surface of a casing 100. In this case, there are following problems.

First, the electronic paper may be peeled off due to some shock while a user is using the mobile terminal well. Moreover, when the user purposely peels the electronic paper, it is difficult to distinguish whether the user has purposely peeled or the electronic paper has been naturally peeled, so that it is difficult for a device maker to cope with user complaints.

Second, in the case of FIG. 2 of the foregoing patent literature, it is difficult to guide the electronic paper to a substrate while protecting an end face of the casing 100 and a flexible substrate (not shown). Because the flexible substrate of the electronic paper is always visible from the exterior through the end face of the exterior display device 106, the flexible substrate may be easily disconnected by an external shock when the user uses the mobile terminal.

Third, according to the mobile terminal of the foregoing parent literature, the electronic paper on the surface is processed to have an irregular shape so as to avoid an interference with an LCD and a key, but it is difficult to form the electronic paper in such a shape by a related technology. The mobile terminal of the foregoing patent literature displays preinstalled information, but as an example case, when contents to be displayed are created by a maker other than the device developing maker, designing of the contents are difficult if the electronic paper is in an irregular (nonstandard) shape, and the compatibility of such contents are poor when a similar mobile terminal is released. Moreover, the electronic paper present at the rear of the mobile terminal where a wide space is secured is hidden as it is located at the rear, so that it is not preferable from the standpoint of design.

Patent literature 2 discloses another example technology having an electronic paper provided on a surface of a casing.

Patent literature 3 discloses a key input device having an electronic paper provided at a character part of a key top.

Patent literature 4 discloses a display unit which utilizes an electronic paper and a noncontact card, receives information from an external device through the noncontact card, and displays the received information on the electronic paper.

Patent literature 5 discloses an electronic device which downloads dress-up data over a network, and displays the acquired dress-up data on an electronic paper.

Patent Literature 1: Unexamined Japanese Patent Application KOKAI Publication No. 2004-192497

Patent Literature 2: Unexamined Japanese Patent Application KOKAI Publication No. 2005-128406

Patent Literature 3: Unexamined Japanese Patent Application KOKAI Publication No. 2005-352987

Patent Literature 4: Unexamined Japanese Patent Application KOKAI Publication No. 2004-127279

Patent Literature 5: Unexamined Japanese Patent Application KOKAI Publication No. 2006-293000

### DISCLOSURE OF INVENTION

### Problem To Be Solved By the Invention

However, as shown in FIG. 12, according to a structure that the LCD is used as a dress-up display member, there is the wasted space 109, and according to the patent literature 1, when the display member comprises the electronic paper and the electronic paper is pasted on a surface of the casing, there are possibilities that the electronic paper may be peeled or the flexible substrate thereof may be disconnected.

Nowhere in foregoing patent literatures 2 to 5 is disclosed means for solving those problems.

It is an object of the present invention to provide a mobile terminal which has no unnecessary space inside a casing and which has no possibility that an electronic paper is peeled or a flexible substrate thereof is disconnected when a display member comprises the electronic paper, a method of dressing up the same, and a dress-up data distribution method.

### Means For Solving the Problem

To overcome the foregoing problem, a mobile terminal of the present invention can change a picture displayed on a casing and comprises: a transparent casing formed of a transparent material; and a display member which is provided at one side of the transparent casing, can change a picture and can keep the display without power after change.

According to the present invention, a method of dressing up a mobile terminal which changes a picture displayed on a casing, the mobile terminal comprising a transparent casing formed of a transparent material, a display member which is provided at one side of the transparent casing, can change a picture and can keep displaying a picture without power after change, a memory unit which stores information to be displayed on the display member, and a control unit which controls the display member and the memory unit, and the method comprising a display step of causing the control unit to read out the information from the memory unit and to instruct the display member to display the information.

According to the present invention, a dress-up data distribution method of distributing information to be displayed on a display member to a mobile terminal comprising a transparent casing formed of a transparent member, and the display member which is provided at one side of the transparent casing, can change a picture displayed on the casing, and can keep displaying the picture without power after change, the method comprising: a providing step in which a device developing maker provides a specification necessary for creating display contents to a contents provider prior to release of the mobile terminal; a creation step in which the contents provider creates dress-up information based on the provided specification; a fee charging step in which the contents provider charges a fee to a user through a communication common carrier when the user finds dress-up information that the user wants to purchase after the mobile terminal is on sale; a download step in which the user downloads the dress-up information that the user wants to purchase after the fee is charged; and a setting step in which the user sets up the downloaded dress-up information to the display member.

According to the present invention, a program which allows a computer to execute a method of dressing up a mobile terminal that changes a picture displayed on a casing, the mobile terminal comprising a transparent casing formed of a transparent material, a display member which is provided at one side of the transparent casing, can change a picture, and can keep displaying a picture without power after change, a memory unit which stores information to be displayed on the display member, and a control unit which controls the display member and the memory unit, and the program allowing the control unit to execute a display step of reading out the information from the memory unit and of causing the display member to display the information.

### Effect of the Invention

According to the present invention, there are provided a mobile terminal which has no unnecessary space inside a casing and which has no possibility that an electronic paper is peeled or a flexible substrate thereof is disconnected when a display member comprises the electronic paper, a method of dressing up the same, and a dress-up data distribution method.

### BRIEF DESCRIPTION OF DRAWINGS

FIG. 1 is a cross-sectional view of a mobile terminal according to a first embodiment of the present invention along a line A-A′;

FIG. 2 is a diagram showing an exterior appearance of a display face of the mobile terminal of the first embodiment and that of a keyboard face thereof (with the mobile terminal being opened);

FIG. 3 is a diagram showing an exterior appearance of a back face of the mobile terminal of the first embodiment (with the mobile terminal being opened);

FIG. 4 is a configuration diagram of the mobile terminal of the first embodiment;

FIG. 5 is a flowchart showing an example of an operation of the first embodiment;

FIG. 6 is a flowchart showing an example of an operation of a mobile terminal according to a second embodiment;

FIG. 7 is a configuration diagram of a mobile terminal according to a fourth embodiment of the present invention;

FIG. 8 is a perspective view showing a mobile terminal according to a fifth embodiment of the present invention;

FIG. 9 is a cross-sectional view of the mobile terminal along a line B-B′;

FIG. 10 is a whole configuration diagram according to the fifth embodiment;

FIG. 11 is a flowchart showing an example of an operation of the fifth embodiment;

FIG. 12 is a cross-sectional view of a related example mobile terminal; and

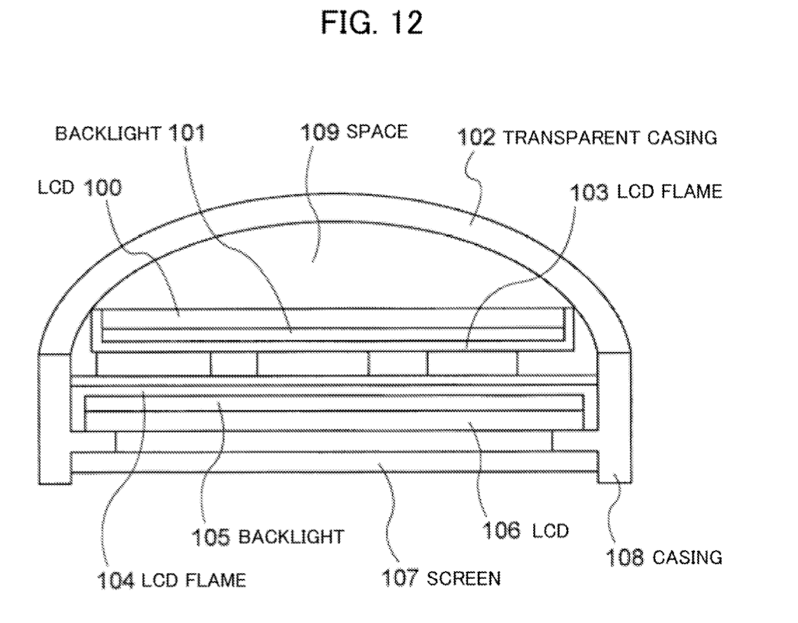

FIG. 13 is a cross-sectional view of an example electronic paper.

### DESCRIPTION OF REFERENCE NUMERALS

201 Transparent casing

202, 513, 803 Electronic paper

203, 273 Power source IC

204, 902 Control IC

205 LCD flame

206 Backlight

207 LCD

208, 514 Casing

209 Flexible substrate (FPC)

210 Connector

211 Driver unit for electric paper

212 Printed board

213 Screen

251 First casing

252 Second casing

253 Hinge unit

254 Display unit

255 Keyboard unit

261 Predetermined device

271 Baseband IC

272 RFIC

274 Battery pack

275 Antenna

307 Electrode

407 Other device like LCD

411, 903 Memory

511 Screen

512 Resistive touch panel

801 Mobile terminal

802 Retain opening

804 Transparent casing

805 Control circuit

806 IO connector

807 Plug

808 AC adapter

811, 914, 915 Wiring

901 Tabletop holder

908 Driver unit

910 Power source circuit

911 Charging protection circuit

913 Power source

### BEST MODE FOR CARRYING OUT THE INVENTION

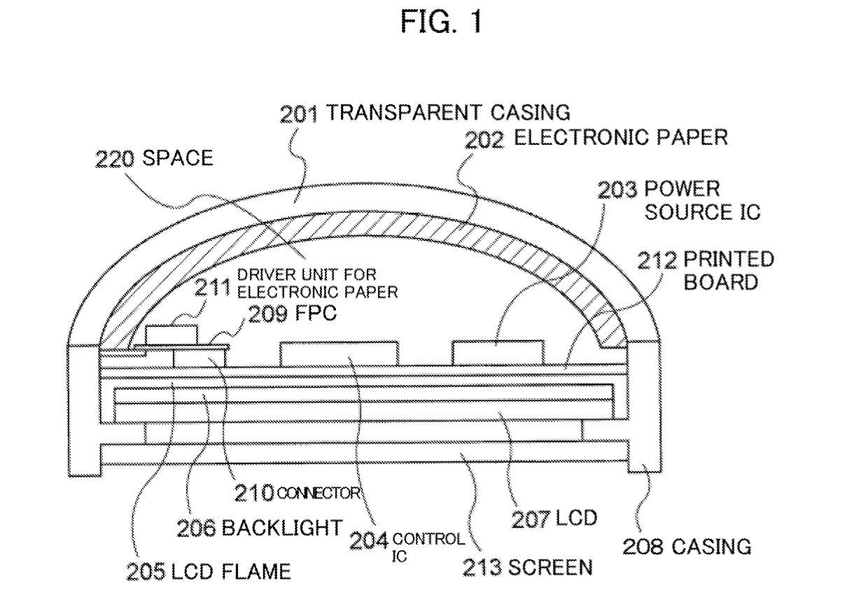

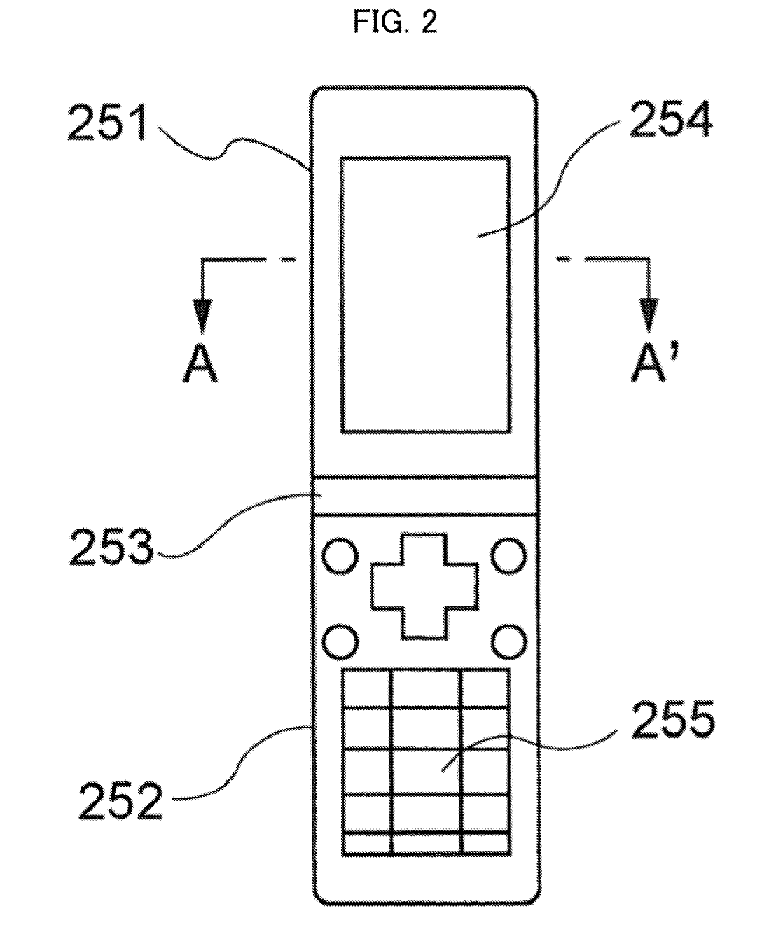

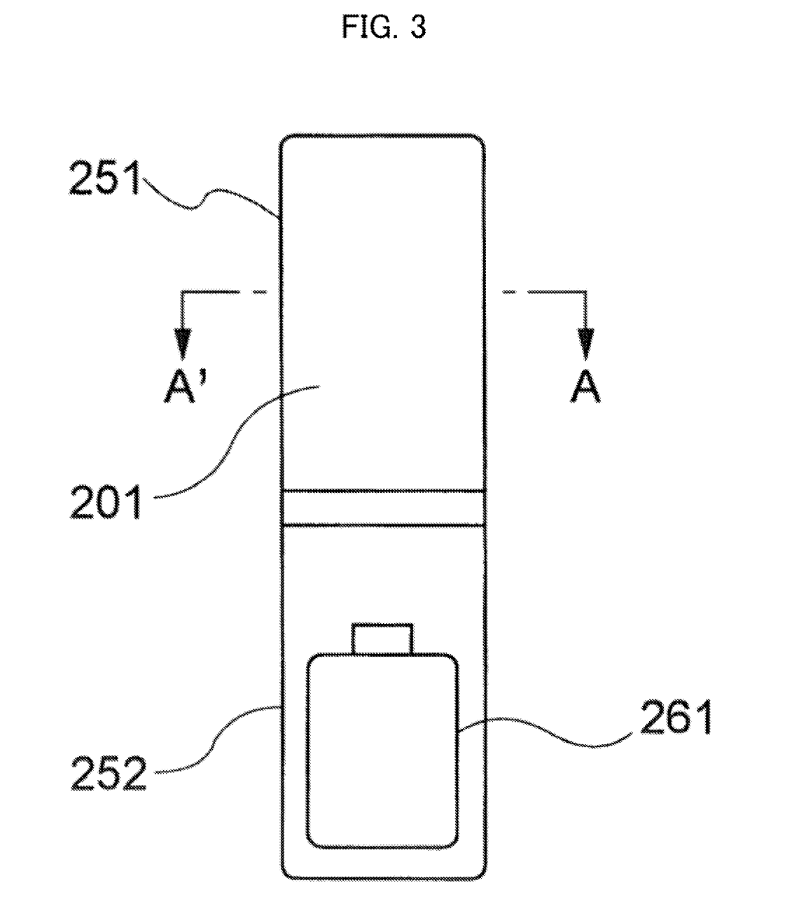

An explanation will be given of embodiments of the present invention with reference to accompanying drawings. First of all, a first embodiment will be explained. FIG. 1 is a cross-sectional view of a mobile terminal according to the first embodiment of the present invention along a line A-A′, FIG. 2 is a diagram showing an exterior appearance of a display face of the mobile terminal of the first embodiment and that of a keyboard face thereof (with the mobile terminal being opened), and FIG. 3 is a diagram showing an exterior appearance of a back face of the mobile terminal of the first embodiment (with the mobile terminal being opened).

As shown in FIGS. 2 and 3, a foldable mobile terminal is adopted in the first embodiment as an example mobile terminal. However, the present invention is not limited to such a type, and can be applied to a solid-type mobile terminal.

With reference to FIG. 2, the mobile terminal of the present invention comprises a first casing 251, a second casing 252, and a hinge unit 253. The first casing 251 and the second casing 252 can be opened and closed through the hinge unit 253.

The first casing 251 has a display unit 254 provided at a front face, and the second casing 252 has a keyboard unit 255 provided at a front face.

With reference to FIG. 3,, the first casing 251 also has a transparent casing 201 provided at a rear face, and the second casing 252 also has a predetermined device 261 provided at a rear face.

FIGS. 2 and 3 have an A-A′ cross-sectional position with respect to the first casing 251, and such a cross-section is shown in FIG. 1.

With reference to FIG. 1, the first casing 251 comprises the transparent casing 201, an electronic paper 202, a power source IC (integrated circuit) 203, a control IC 204, an LCD flame 205, a backlight 206, an LCD 207, a casing 208, a flexible substrate (FPC: flexible printed circuit) 209, a connector 210, a driver unit 211 for the electronic paper, and a printed board 212.

The LCD configures a display face, has the backlight 206 at a rear face, and has a screen 213 at a front face. The LCD 207 and the backlight 206 are supported by the LCD flame 205, and the screen 213 is supported by the casing 208.

In contrast, the electronic paper 202 configures a dress-up screen, and is pasted on a rear face of the transparent casing 201.

The printed board 212 is provided with the power source IC 203, the control IC 204, and the connector 210.

The connector 210 and the electronic-paper driver unit 211 are connected together via the flexible substrate 209.

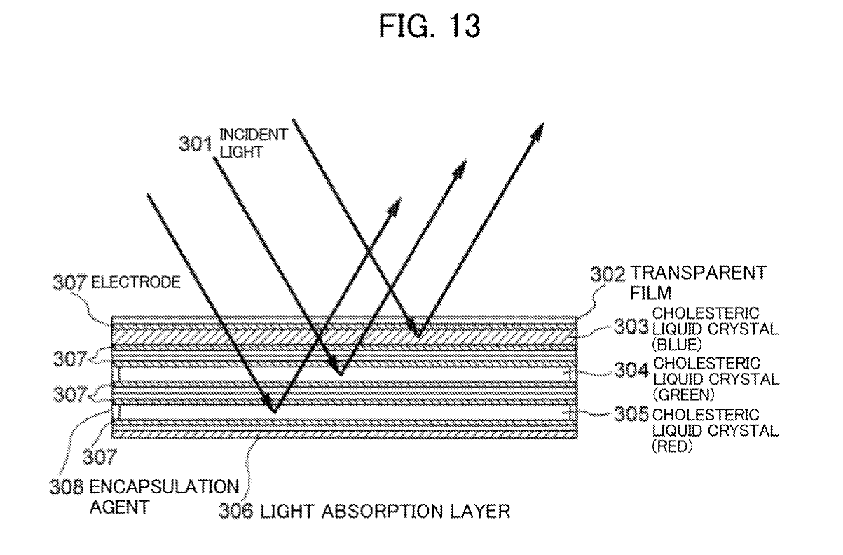

One end of the flexible substrate 209 is connected to an electrode 307 (see FIG. 13) of the electronic paper 202.

The electronic paper 202 is pasted on the transparent casing 201 by means of an adhesion tape or, the like at a portion where display is not interrupted.

The electronic paper 202 is electrically connected to the printed board 212 via the electrode 307 shown in FIG. 13 above the electronic paper 202, the flexible substrate 209, the electronic-paper driver unit 211, and the connector 210.

The control IC 204 for a display updating control and the power source IC 203 for supplying power are connected together via wirings on the printed board 212.

Peripheral part around the LCD 207 employs a structure employed by general foldable mobile terminals, thus omitting explanation thereof.

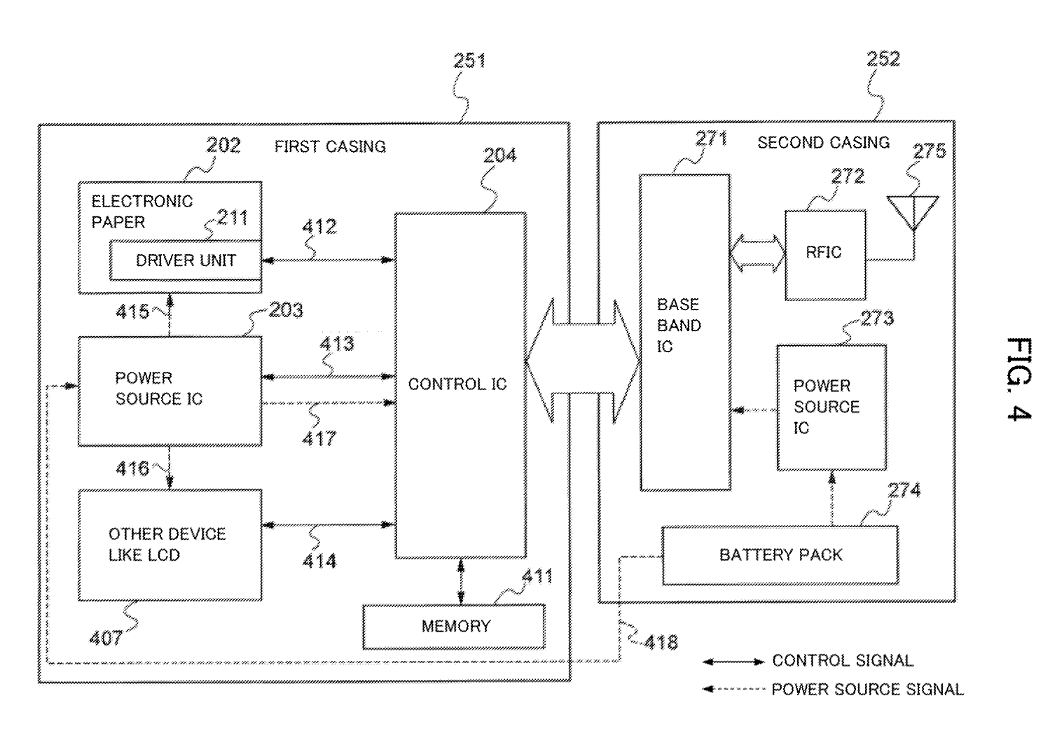

Next, an explanation will be given of a configuration of the mobile terminal according to the first embodiment of the present invention. FIG. 4 is a configuration diagram of the mobile terminal of the first embodiment. In FIG. 4, the same element as that shown in FIG. 1 will be denoted by the same reference numeral, and the explanation thereof will be omitted.

With reference to the figure, in the first embodiment, the mobile terminal comprises the first casing 251 and the second casing 252.

The first casing 251 comprises the electronic paper 202, the electronic-paper driver unit 211, the power source IC 203, other device 407 like an LCD, the control IC 204, and a memory 411.

The electronic paper 202 updates a display content through the electronic-paper driver unit 211 based on a control signal 412 from the control IC 204. Dress-up display data and a program necessary for an operation are stored in the memory 411.

Regarding the dress-up display data, one stored in the memory 411 can be used, and in addition, contents may be downloaded over a communication network like the Internet, stored and extracted in the memory 411.

A power source signal 415 for the electronic paper 202 is supplied from the power source IC 203. The power source signal 415 can be output or terminated as the control IC 204 controls the power source IC 203.

After a display content is updated, the power source IC 203 terminates outputting and executes an operation which does not consume power. Power is supplied to the power source IC 203 from a battery pack 274 to be discussed later.

The second casing 252 comprises a baseband IC 271, an RFIC 272, a power source IC 273, the battery pack 274, and an antenna 275.

The RFIC 272 transmits a signal via the antenna 275, or receives a signal via the antenna 275. The baseband IC 271 converts a signal from the RFIC 272 into a baseband signal, or converts a baseband signal into an RF signal, and outputs such a signal to the RFIC 272.

The power source IC 273 supplies power to the baseband IC 271. The battery pack 274 supplies power to the power source ICs 273 and 203.

Note that the configuration of the second casing 252 is same as a transmission/reception unit of general mobile terminals, so that detailed explanation thereof will be omitted.

Next, an explanation will be given of an outline of an operation of the first embodiment. The electronic paper with a rewritable color is pasted on the rear face of the transparent casing 201 in such a manner as to be arranged along a curved face of the casing 201 so that the electronic paper 202 can be viewed from the exterior. The electronic paper 202 is connected to the control IC 204 via the printed board 212, and displays a picture to be displayed under a software control.

After a display content is rewritten, power supply to the electronic paper 202 is terminated, and the electronic paper 202 maintains display information.

In this condition, a user can enjoy a picture displayed on the electronic paper 202 through the transparent casing 201. Because the electronic paper 202 can maintain information once displayed without power, it is suitable for dress-up.

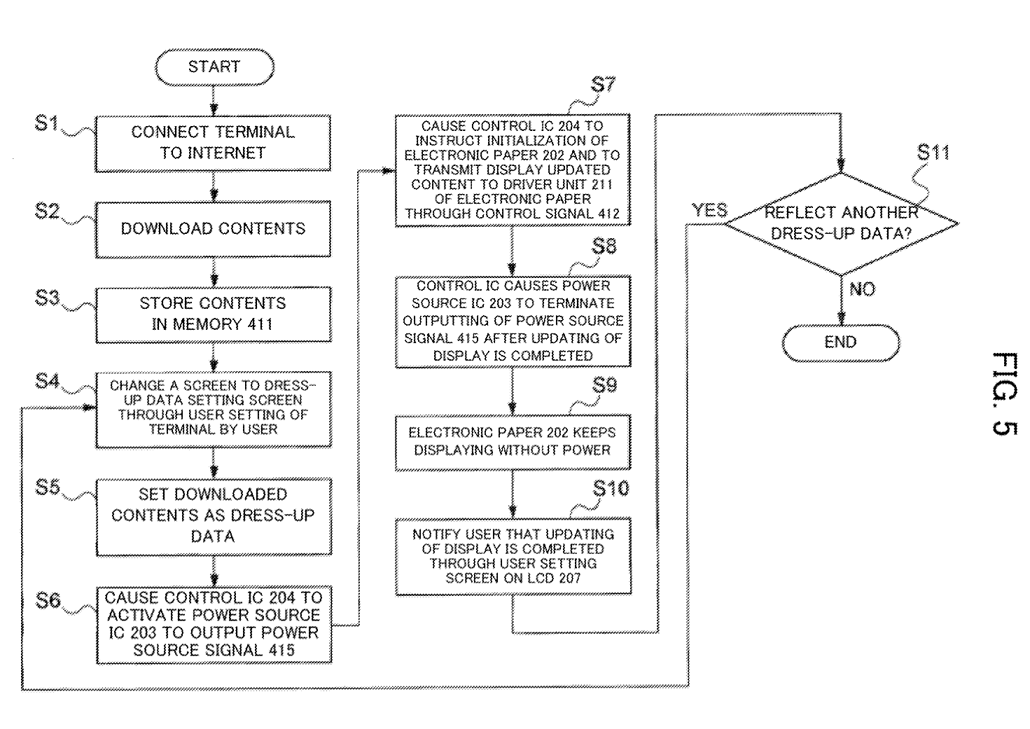

Next, an explanation will be given of an operation of the first embodiment in detail with reference to FIG. 5. FIG. 5 is a flowchart showing an example of the operation of the first embodiment. Note that the following operation is executed as the control IC 204 in the first casing 251 controls each element 202, 203, 407, 411 and 271.

The embodiment is for an example operation flow of updating a display of the electronic paper 202 using dress-up data downloaded over the communication network like the Internet. However, as such dress-up data, one stored in the memory 411 beforehand can be also used.

First, the user connects the mobile terminal to the communication network, e.g., the Internet (step S1), and downloads dress-up data from a website (step S2). The downloaded contents are stored in the memory 411 shown in FIG. 4 (step S3).

In order to set the dress-up data to the mobile terminal, the LCD 207 shown in FIG. 1 displays a user setting screen (step S4), and the contents are set through such a screen (step S5).

At this time, the control IC 204 supplies a control signal 413 to the power source IC 203 to control the power source IC 203 to output the power source signal 415 (step S6). Accordingly, power is input to the electronic paper 202, and the electronic paper 202 becomes a condition in which rewriting is possible.

The control IC 204 transmits a control signal 412 to the electronic-paper driver unit 211 to instruct initialization of the electronic paper 202 and to send a display update content from the memory 411 (step S7).

After updating of the display of the electronic paper 202 is completed, the control IC 204 causes the power source IC 203 to terminate outputting of the power source signal 415 (step S8). Accordingly, the electronic paper 202 keeps displaying without power (step S9). That is, because power in the battery pack 274 is not used, it does not result in reduction of a battery standby time.

Eventually, a notification to the effect that updating of the display is completed is given to the user through the user setting screen on the LCD 207 (step S10). In a case in which the user changes dress-up data again at this time (step S11: YES), the setting is started over from the step S4. Conversely, in a case in which the user does not change the dress-up data again (step S11: NO), the operation is terminated.

As explained above, according to the first embodiment of the present invention, as the mobile terminal downloads dress-up data, a picture is displayed on the electronic paper arranged inside the mobile terminal, and it becomes possible to create a mobile terminal dressed up differently user by user.

Moreover, as the electronic paper is pasted on the curved casing, it becomes possible to realize dress-up united with the design. While at the same time, a configuration which has no wasted internal space is realized.

As the electronic paper is pasted from the rear face of the casing, it is possible to protect the electronic paper.

The explanation has been given of the problem of the related technology that it is difficult to distinguish whether the user had consciously peeled the electronic paper or the electronic paper had naturally peeled when the user consciously peels it, according to the present invention, in contrast, because the electronic paper is arranged inside the casing, it is not possible for the user to directly peel the electronic paper, and the user needs to open the casing itself in order to consciously peel the electronic paper. In this case, because it is general that a seal which indicates that the casing is opened (e.g., a seal which leaves some patterns on the casing when peeled) is pasted on the casing when the casing is opened, it is possible to determine whether or not peeling of the electronic paper is a conscious breakage according to the present invention.

As the electronic paper is arranged inside the upper casing of the mobile terminal in the condition shown in FIG. 2, it is possible to view the electronic paper from the exterior at a glance, there is a great advantage for the designing, and such a condition is extensional and most appropriate because it is not necessary to form the electronic paper in an irregular shape.

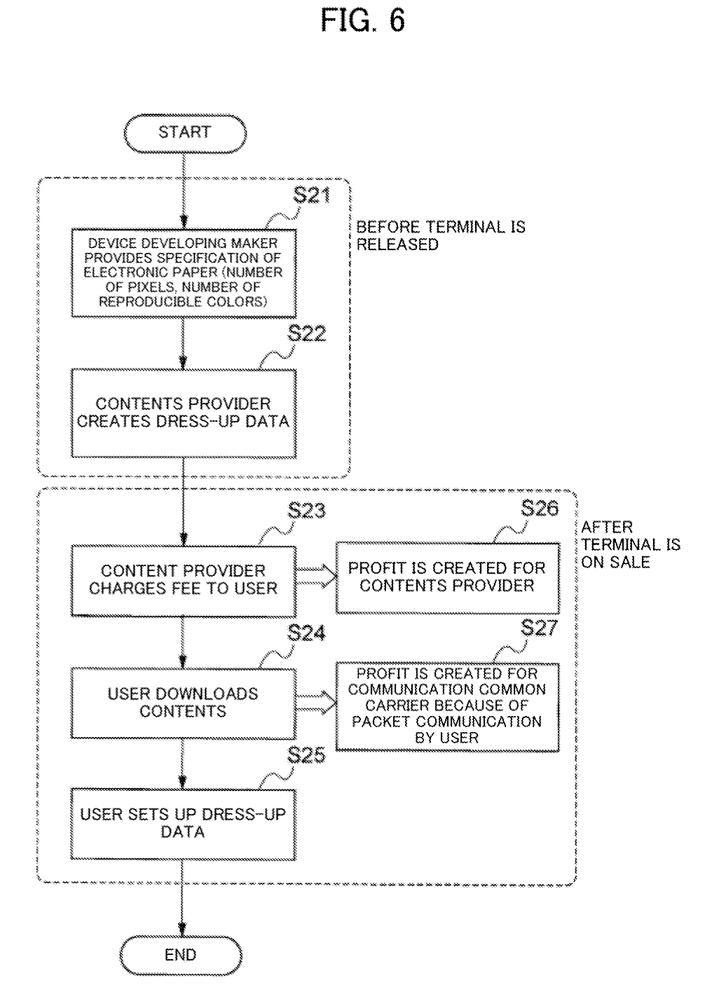

Next, an explanation will be given of a second embodiment. The second embodiment relates to how to distribute dress-up data. FIG. 6 is a flowchart showing an example of an operation of a mobile terminal according to the second embodiment.

First, before the mobile terminal is sold on the market, a device developing maker provides specifications necessary to create contents, such as the number of pixels, and the number of reproducible colors, to a contents provider (step S21).

In response to this, the contents provider creates dress-up data (step S22).

When a user finds dress-up data that the user wants to purchase after the mobile terminal becomes available on the market, as the contents provider charges a fee to the user through a communication common carrier (step S23), the user becomes able to download the contents (step S24). As the user sets up the downloaded dress-up data to the mobile terminal (step S25), the electronic paper displays an image corresponding to the dress-up data.

A profit is created for the contents provider at this stage (step S26). Moreover, a packet communication fee becomes also requisite when the user downloads the contents, so that a profit is also created for the communication common carrier at this stage (step S27).

Eventually, as users exhibit dress-up data varying one by one in town, it becomes an advertising and a sales promotion of the mobile terminal, so that it becomes possible to expect increasing of the number of sales of the mobile terminals.

As explained above, according to the second embodiment, as new contents for mobile terminals which are distribution of dress-up data are created, it is possible to provide a new contents business.

Next, an explanation will be given of a third embodiment. The third embodiment relates to a technology of acquiring dress-up data using a noncontact IC card.

Recent mobile terminals often have a built-in non-contact IC card like a so-called “OSAIFU KEITAI”. It is possible to establish a structure of acquiring dress-up panel information which can be acquired at only one local place using a noncontact IC card technology with a mobile terminal at a contents spot in town.

As explained above, according to the third embodiment, as dress-up data contents are acquired using a noncontact IC card not through a communication network like the Internet, a method of acquiring dress-up data can be expanded.

In this case, unlike the communication network like the Internet, a new limited structure is created that a user cannot acquire dress-up data if the user does not go to a contents spot where a noncontact-IC-card input/output device is provided.

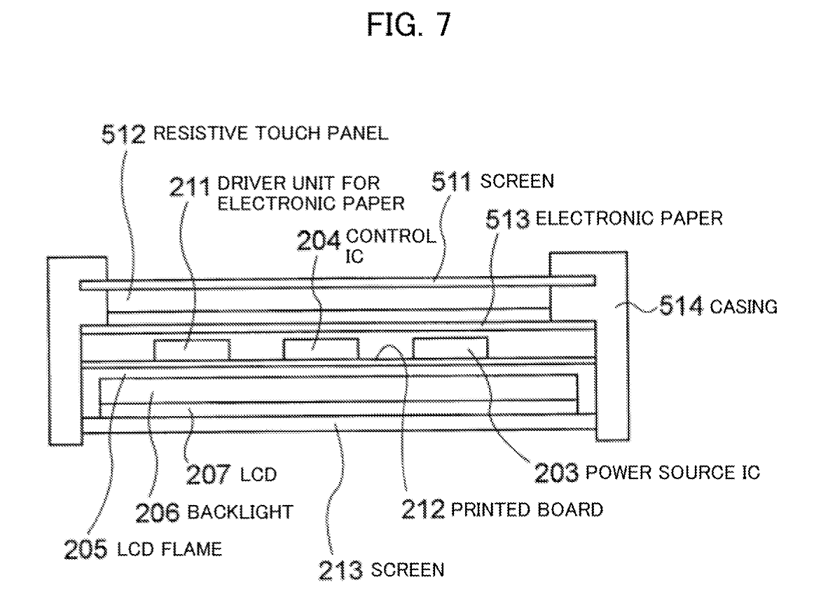

Next, an explanation will be given of a fourth embodiment. The fourth embodiment relates to a technology which combines an electronic paper and a resistive touch panel. FIG. 7 is a configuration diagram of a mobile terminal according to the fourth embodiment of the present invention. In FIG. 7, the same element as that shown in FIG. 1 will be denoted by the same reference numeral, and the explanation thereof will be omitted.

With reference to FIG. 7, a mobile terminal according to the fourth embodiment of the present invention comprises a screen 511, a resistive touch panel 512, an electronic paper 513, a casing 514, the power source IC 203, the control IC 204, the LCD flame 205, the backlight 206, the LCD 207, the printed board 212, and the screen 213.

The electronic paper 513 is arranged under the screen 511 (corresponding to the transparent casing 201 in FIG. 1) and the resistive touch panel 512, and unlike the first embodiment (see FIG. 1), a predetermined clearance is required between the electronic paper 513 and the screen 511.

With the electronic paper 513 being in a rewritable condition, as a user draw a picture through the resistive touch panel 512, it is possible to create original dress-up data. However, because the resistive touch panel 512 is basically not flexible, it is difficult to arrange the electronic paper in an inflected manner like the first embodiment.

As explained above, according to the fourth embodiment, because the resistive touch panel 512 is transparent, it is possible to arrange the electronic paper 513 in an overlapped manner with the resistive touch panel 512.

Moreover, it is possible to easily create dress-up data through the resistive touch panel 512. In this case, because the resistive touch panel 512 is overlapped with the electronic paper 513, it is possible to create dress-up data at the same scale factor.

In contrast, according to the related technology, when dress-up data is created by inputting data from the LCD 207, because the LCD 207 and the electronic paper 513 have different sizes, there is a disadvantage that the data is created in a different scale factor. Moreover, because a picture is drawn using the keyboard, it takes a time in comparison with handwriting.

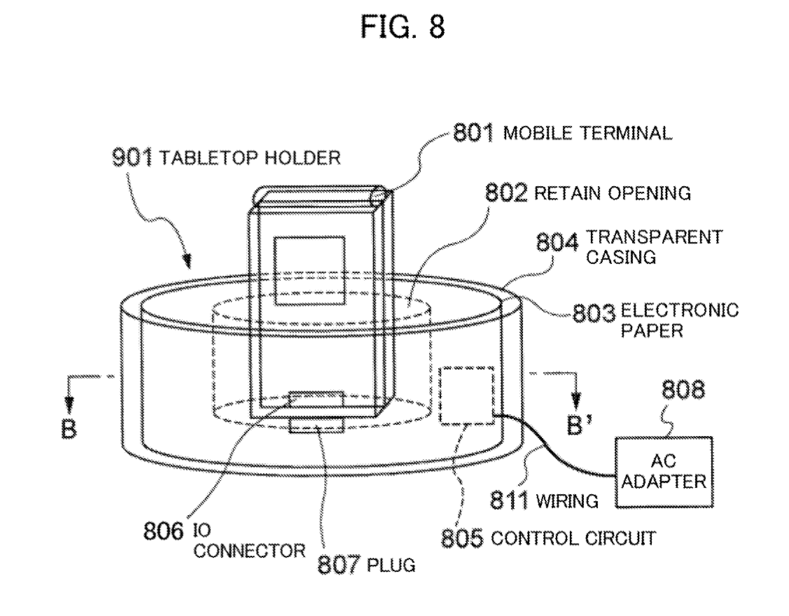

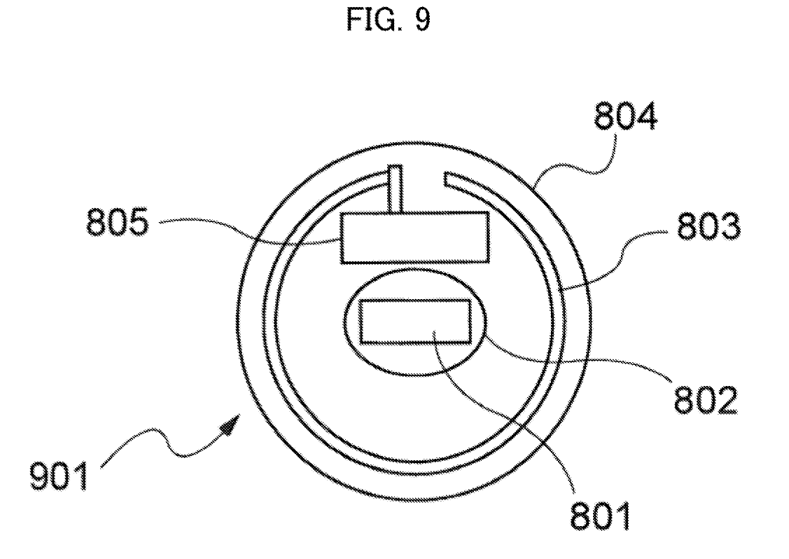

Next, an explanation will be given of a fifth embodiment. The fifth embodiment relates to a technology of mounting an electronic paper on a tabletop holder. FIG. 8 is a perspective view showing a mobile terminal according to the fifth embodiment of the present invention, and FIG. 9 is a cross-sectional view of the mobile terminal along a line B-B′. In FIG. 9, the same element as that in FIG. 8 will be denoted by the same reference numeral, and the explanation thereof will be omitted.

With reference to FIG. 8, a tabletop holder 901 comprises a retain opening 802, an electronic paper 803, a transparent casing 804, a control circuit 805, an IO connector 806, and a plug 807.

The tabletop holder 901 externally has an AC adapter 808 and a wiring 811 connecting the AC adapter 808 and the control circuit 805.

A mobile terminal 801 is retained in the retain opening 802.

As shown in FIG. 8, the tabletop holder 901 is in a cylindrical shape. Because the electronic paper 803 can be arranged in a bent condition, as shown in the figure, the electronic paper 803 is arranged in a rolled and bent condition. The transparent casing 804 covers such an electronic paper 803.

A user can enjoy information displayed on the electronic paper 803 through the transparent casing 804.

The mobile terminal 801 is connected to the tabletop holder 901 via the IO connector 806 and the plug 807 in the tabletop holder 901. The plug 807 is connected to the control circuit 805 for controlling the electronic paper 803 in the tabletop holder 901.

The IO connector 806 of the mobile terminal 801 includes a terminal for charging, and is connected to the AC adapter 808 via a circuit board (not illustrated) in the tabletop holder 901, the control circuit 805 and the wiring 811.

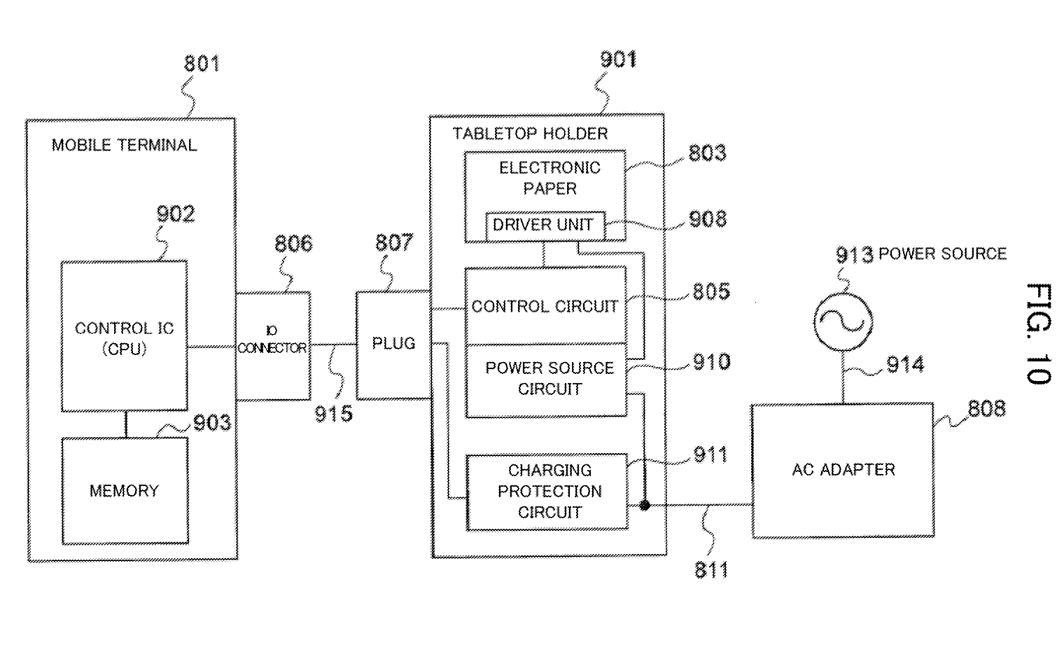

Next, an explanation will be given of a whole configuration of the fifth embodiment. FIG. 10 is a whole configuration diagram according to the fifth embodiment. Note that the same element as that in FIGS. 8 and 9 will be denoted by the same reference numeral, and the explanation thereof will be omitted.

With reference to FIG. 10, the mobile terminal 801 comprises a control IC (CPU: central processing unit) 902, a memory 903, and the IO connector 806.

The tabletop holder 901 comprises the plug 807, the electronic paper 803, a driver unit 908, the control circuit 805, a power source circuit 910, and a charging protection circuit 911.

Moreover, the tabletop holder 901 externally has the AC adapter 808, a power source 913, a wiring 811 connecting the charging protection circuit 911 and the AC adapter 808, and a wiring 914 connecting the AC adapter 808 and the power source 913.

Furthermore, the tabletop holder 901 has a wiring 915 connecting the IO connector 806 and the plug 807.

The electronic paper 803 displays dress-up data stored in the memory 903 under a control by the control IC 902 in the mobile terminal 801. At this time, dress-up data is transferred from the memory 903 to the control IC 902, the IO connector 806, the plug 807, the control circuit 805, the driver unit 908, and the electronic paper 803, in this order.

Regarding a power source for driving the electronic paper, a battery of the mobile terminal 801 is not used, but power acquired from the AC adapter 808 is used. That is, power is supplied from the power source 913 to the wiring 914, the AC adapter 808, the wiring 811, the power source circuit 910, and the driver unit 908 in this order.

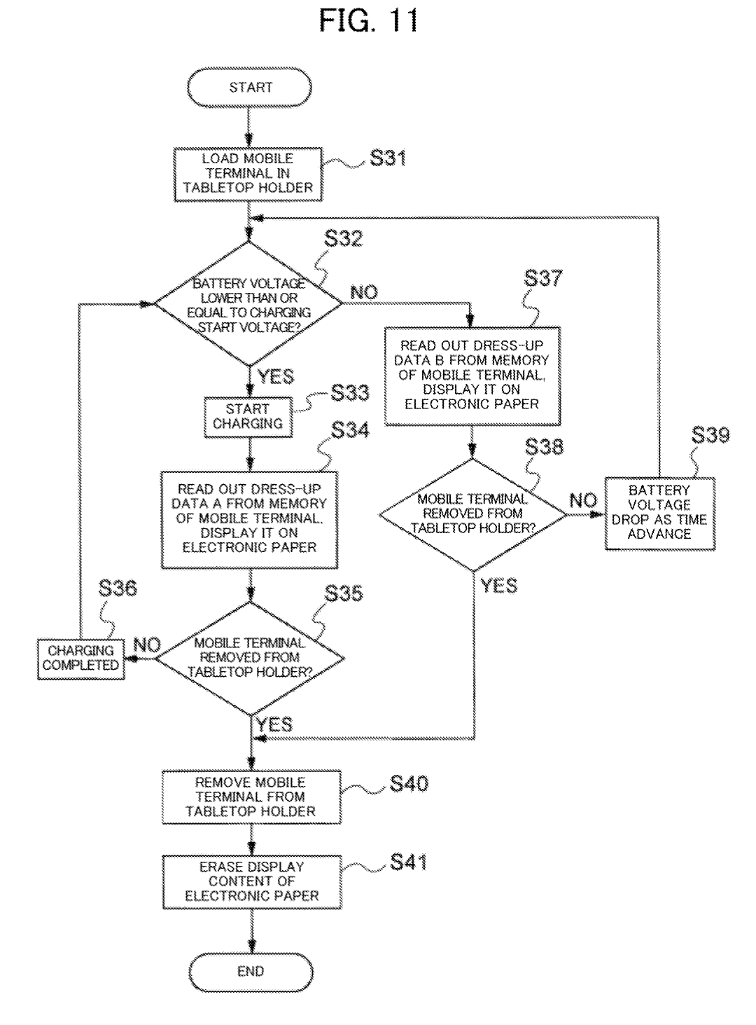

Next, an explanation will be given of an example of an operation of the fifth embodiment. FIG. 11 is a flowchart showing an example of an operation of the fifth embodiment. Hereinafter, as an example operation, an explanation will be given of an operation of changing a display of the electronic paper 803 in the tabletop holder 901 when the mobile terminal 801 is in charging and when charging is terminated.

First, the mobile terminal 801 is loaded in the tabletop holder 901 (step S31). Next, the mobile terminal 801 determines whether or not charging of the battery is necessary (step S32).

When charging of the battery is necessary (step S32: YES), a charging circuit (not illustrated) in the mobile terminal 801 starts charging (step S33).

After charging is started, dress-up data A written in the memory 903 of the mobile terminal 801 is expanded on the electronic paper 803 of the tabletop holder 901 (step S34). The dress-up data A at this time is for notifying a user that the mobile terminal 801 is in charging.

Next, as the mobile terminal 801 is removed from the tabletop holder 901 (step S35: YES and step S40), the display content of the electronic paper 803 is erased (step S41).

Conversely, when the mobile terminal 801 is not removed from the tabletop holder 901 at the step S35 (step S35: NO), charging is continued, and when charging is completed (step S36), the process returns to the step S32.

In contrast, when charging of the battery is unnecessary at the step S32 (step S32: NO), a normal standby condition is maintained, and dress-up data B is expanded on the electronic paper 803 of the tabletop holder 901 (step S37). The dress-up data B is for notifying the user that charging is not carried out (charging is unnecessary).

Next, as the mobile terminal 801 is removed from the tabletop holder 901 (step S38: YES and step S40), the display content of the electronic paper 803 is erased (step S41).

Conversely, when the mobile terminal 801 is not removed from the tabletop holder 901 at the step S38 (step S38: NO), the battery voltage drops as time advances (step S39), and the process returns to the step S32.

Note that it is also possible to display different dress-up data in accordance with a condition of the mobile terminal like missing of a call or reception of a mail in addition to the foregoing examples.

As explained above, according to the fifth embodiment, the dress-up function of the casing in the first to fourth embodiments is applied to the tabletop holder. That is, as shown in FIG. 8, as the electronic paper is arranged in the tabletop holder in a rolled and bent condition, it is possible to enjoy dress-up data with a 360-degree view. Moreover, because contents downloaded through a communication network like the Internet is expanded from the memory of the mobile terminal, the number of display contents becomes infinity.

Next, an explanation will be given of a sixth embodiment. The sixth embodiment relates to a program for the dress-up method.

A program for the dress-up method shown by the flowcharts of FIGS. 5 and 11 is stored in the memory 411 inside the first casing 251 of the mobile terminal and the memory 903 of the mobile terminal 801.

The control IC 204 inside the first casing 251 of the mobile terminal shown in FIG. 4 reads out the dress-up-method program from the memory 411, and causes the electronic paper 202, the driver unit 211, the power source IC 203, and the other device 407 like the LCD to execute the processes of the dress-up method.

Likewise, the control IC 902 inside the mobile terminal 801 reads out the dress-up-method program from the memory 903, and causes the electronic paper 803 in the tabletop holder 901, the driver unit 908, the control circuit 805, the power source circuit 910 and the charging protection circuit 911 to execute the processes of the dress-up method via the IO connector 806 and the plug 807.

Those processes have been explained above, thus omitting the explanation thereof.

As explained above, according to the sixth embodiment of the present invention, there is provided the program for the dress-up method of the mobile terminal which has no unnecessary space inside the casing and which has no possibility that the electronic paper is peeled or the flexible substrate thereof is disconnected when the display member comprises the electronic paper.

The present application is based on Japanese Patent Application No. 2007-200273 filed on Aug. 1, 2007, and the entire contents of Japanese Patent Application No. 2007-200273 are incorporated herein by reference.

### INDUSTRIAL APPLICABILITY

The present invention can be applied to a mobile terminal, such as a cellular phone, a laptop computer with a communication function, a PHS (personal handy phone system), or a PDA (personal data assistance, Personal digital assistants: a portable information communication device for personal use) with a communication function.

1. A mobile terminal which can change a picture displayed on a casing comprising:
a transparent casing formed of a transparent material; and
a display member which is provided at one side of the transparent casing, can change a picture and can keep displaying a picture without power after change.

2. The mobile terminal according to claim 1, wherein the display member is pasted on a rear face of the transparent casing.

3. The mobile terminal according to claim 1, wherein the transparent casing has a curved face.

4. The mobile terminal according to claim 1 further comprising control unit for controlling a display of the display member.

5. The mobile terminal according to claim 4, further comprising memory unit for storing information to be displayed on the display member, and wherein
the control unit reads out the information from the memory unit, and causes the display member to display the information.

6. The mobile terminal according to claim 4, wherein the control unit is connected to a communication network, acquires information to be displayed on the display member from an external device over the communication network, and causes the display member to display the information.

7. The mobile terminal according to claim 6, further comprising a noncontact card which communicates with the external device without a contact, and wherein
the control unit is connected to the communication network through the noncontact card, and acquires information to be displayed on the display member from the external device through the communication network and the noncontact card.

8. The mobile terminal according to claim 1, wherein the transparent casing comprises a touch panel.

9. The mobile terminal according to claim 1, further comprising a tabletop holder which supports a main body of the mobile terminal, and wherein
the tabletop holder comprises the transparent casing and the display member.

10. A method of dressing up a mobile terminal which changes a picture displayed on a casing, the mobile terminal comprising a transparent casing formed of a transparent material, a display member which is provided at one side of the transparent casing, can change a picture and can keep displaying a picture without power after change, a memory unit which stores information to be displayed on the display member, and a control unit which controls the display member and the memory unit, and the method comprising:
a display step of causing the control unit to read out the information from the memory unit and to instruct the display member to display the information.

11. The mobile-terminal dress-up method according to claim 10, further comprising:
a connection step of connecting the control unit to a communication network;
an acquisition step of causing the control unit to acquire information to be displayed on the display member from an external device over the communication network; and
a storing step of causing the control unit to store the acquired information in the memory unit.

12. The mobile-terminal dress-up method according to claim 10, wherein:
the mobile terminal further comprises a tabletop holder which supports a main body of the mobile terminal; and
the tabletop holder comprises the transparent casing and the display member, and
the method further comprises a display step of causing the control unit to read out the information from the memory unit, and to instruct the display member of the tabletop holder to display the information.

13. A dress-up data distribution method of distributing information to be displayed on a display member to a mobile terminal comprising a transparent casing formed of a transparent member, and the display member which is provided at one side of the transparent casing, can change a picture displayed on the casing, and can keep displaying the picture without power after change, the method comprising:
a providing step in which a device developing maker provides a specification necessary for creating display contents to a contents provider prior to release of the mobile terminal;
a creation step in which the contents provider creates dress-up information based on the provided specification;
a fee charging step in which the contents provider charges a fee to a user through a communication common carrier when the user finds dress-up information that the user wants to purchase after the mobile terminal is on sale;
a download step in which the user downloads the dress-up information that the user wants to purchase after the fee is charged; and
a setting step in which the user sets up the downloaded dress-up information to the display member.

14. A program which allows a computer to execute a method of dressing up a mobile terminal that changes a picture displayed on a casing, the mobile terminal comprising a transparent casing formed of a transparent material, a display member which is provided at one side of the transparent casing, can change a picture, and can keep displaying a picture without power after change, a memory unit which stores information to be displayed on the display member, and a control unit which controls the display member and the memory unit; and
the program allowing the control unit to execute a display step of reading out the information from the memory unit and of causing the display member to display the information.
